(19) United States
(12) Patent Application Publication
(10) Pub. No.: US 2026/0099583 A1
(43) Pub. Date: Apr. 9, 2026

(54) IMPLEMENTATION OF DEVICE SEAMLESS UPDATE WITH PRE-AUTHORIZATION POLICY IN TRUSTED EXECUTION ENVIRONMENT

(71) Applicant: Intel Corporation, Santa Clara, CA (US)

(72) Inventors: Jiewen Yao, Shanghai (CN); Shamanna Datta, Hillsboro, OR (US); Mahesh Natu, Folsom, CA (US); Xiaoyu Ruan, Folsom, CA (US); Andrew Draper, Chesham, Bucks (GB); Raghunandan Makaram, Northborough, MA (US); Alberto Munoz, Los Altos, CA (US)

(73) Assignee: Intel Corporation, Santa Clara, CA (US)

(21) Appl. No.: 18/993,879

(22) PCT Filed: Aug. 25, 2022
(86) PCT No.: PCT/CN2022/114781

§ 371 Date: Jan. 13, 2025

(51) Int. Cl. G06F 21/53; G06F 21/57

(52) U.S. Cl. CPC G06F 21/53; G06F 21/575

(57) ABSTRACT

A system and method of enhancing the implementation of device seamless updates with a pre-authorization policy in Trusted Execution Environments include setting a device update pre-authorization policy while establishing a connection with the device, indicating that pre-authorization is necessitated for updating the device, receiving a pre-authorization event from the device, where the pre-authorization event indicates an update for the device has been activated, determining whether the device is authorized to perform the update, and sending a response indicating whether the device is authorized to perform the update to the device.

### CLAIM OF PRIORITY

This application claims, under 35 U.S.C. § 371, the benefit of and priority to International Application No. PCT/CN2022/114781, filed Aug. 25, 2022, titled IMPLEMENTATION OF DEVICE SEAMLESS UPDATE WITH PRE-AUTHORIZATION POLICY IN TRUSTED EXECUTION ENVIRONMENT, the entire content of which is incorporated herein by reference.

### FIELD

Embodiments relate generally to computer security, and more particularly, to the implementation of device seamless updates with a pre-authorization policy in Trusted Execution Environments.

### BACKGROUND

A Data Center platform consists of multiple components and each component generally consists of a combination of hardware and firmware. The Data Center customers such as the cloud service provides (CSPs) need the ability to update the component firmware at will for various reasons including introducing new capabilities and/or applying a security fix. To keep the platform running for as long as possible without reset, a seamless update, i.e., a firmware update, must be performed without a device reset or a system reset. Existing solutions for device attestation include late-verification techniques. For example, the device performs a firmware update before a Trusted Execution Environment attests the device and/or evaluates the firmware update. As such, existing solutions leave a gap of time when the updated device is not trusted and require blind authorization of updates.

### BRIEF DESCRIPTION OF THE DRAWINGS

So that the manner in which the above recited features of the present embodiments can be understood in detail, a more particular description of the embodiments, briefly summarized above, may be had by reference to embodiments, some of which are illustrated in the appended drawings. It is to be noted, however, that the appended drawings illustrate only typical embodiments and are therefore not to be considered limiting of its scope. The figures are not to scale. In general, the same reference numbers will be used throughout the drawings and accompanying written description to refer to the same or like parts.

FIG. 1 illustrates a computing device employing an authorization mechanism according to some embodiments.

FIG. 2 illustrates the authorization mechanism of FIG. 1 according to some embodiments.

FIG. 3 illustrates confidential compute architecture according to some embodiments.

FIG. 4 illustrates a flow for a launch time pre-authorization policy setup according to some embodiments.

FIG. 5 illustrates a flow for a runtime pre-authorization control according to some embodiments.

FIG. 6 illustrates a method for a device seamless update with a pre-authorization policy according to some embodiments.

FIG. 7 is a schematic diagram of an illustrative electronic computing device to enhance the device seamless update with a pre-authorization policy processing according to some embodiments.

### DETAILED DESCRIPTION

Implementations of the technology described herein provide a method and system for the enhancement of the implementation of device seamless updates with a pre-authorization policy in Trusted Execution Environments (TEE).

A Data Center platform consists of multiple components and each component generally consists of a combination of hardware and firmware. The Data Center customers such as the cloud service provides (CSPs) need the ability to update the component firmware at will for various reasons including introducing new capabilities and/or applying a security fix. To keep the platform running for as long as possible without reset, a seamless update, i.e., a firmware update, must be performed without a device reset or a system reset. Existing solutions for device attestation include late-verification techniques. For example, the device performs a firmware update before a Trusted Execution Environment attests the device and/or evaluates the firmware update. As such, existing solutions leave a gap of time when the updated device is not trusted and require blind authorization of updates.

The novel technology described herein facilitates a trust domain (TD) based pre-authorization policy control for device seamless updates in a TEE such as Trust Domain Extension (TDX) with device Input/Output (IO) (TDX-IO). Runtime updates are an industry trend for Data Center environments. The novel technology described herein enables a robust and flexible policy check for a device seamless update by extensions to industry standard Security Protocol and Data Model (SPDM) protocol. As such, all devices that support SPDM protocol may use the novel technology described herein to support pre-authorization for device runtime updates. The Data Center environment may include TDX-IO technology to facilitate seamlessly updating device firmware without disrupting customer (e.g., CSPs) workloads running inside a TD. As such, a device needs to maintain secure communication alive with an assigned TD during the firmware update process. In addition, the TD may approve or disapprove a new firmware version based on TD's security policy before the update is applied to the device.

Embodiments may be employed for enhancing the implementation of device seamless updates with a pre-authorization policy in TEE and/or TDX-IO. One or more components of the TDX-IO may provision a pre-authorization policy (e.g., PreAuthPolicy) that may determine if a device is required to ask the one or more host components for a pre-authorization before activating a runtime update.

In one example, a device may signal a pre-authorization event (e.g., PreAuthEvent) message to the host component when the device has received a new firmware image but has not activated it. The host component may collect the device update information, determine to accept or reject the firmware update, and communicate the decision via a pre-authorization event acknowledgement (PreAuthEventAck) message. The device either performs the runtime update or drops the runtime update based on the PreAuthEventAck indication. In one example, a host component may receive an out of band (OOB) event, such as from a cloud orchestrator or from an update initiator to trigger the pre-authorization process. As such, the host components may influence device updates (e.g., authorize updates before they can happen) so that they maintain trust on the device.

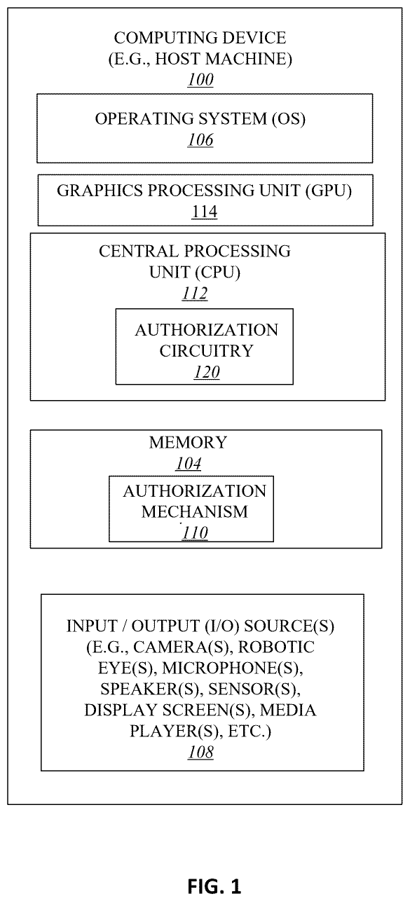

FIG. 1 illustrates a computing device 100 employing an authorization mechanism 110 according to one embodiment. Computing device 100 represents a communication and data processing device including or representing (without limitation) smart voice command devices, intelligent personal assistants, home/office automation system, home appliances (e.g., washing machines, television sets, etc.), mobile devices (e.g., smartphones, tablet computers, etc.), gaming devices, handheld devices, wearable devices (e.g., smartwatches, smart bracelets, etc.), virtual reality (VR) devices, head-mounted displays (HMDs), Internet of Things (IOT) devices, laptop computers, desktop computers, server computers, set-top boxes (e.g., Internet-based cable television set-top boxes, etc.), global positioning system (GPS)-based devices, automotive infotainment devices, etc.

In some embodiments, computing device 100 includes or works with or is embedded in or facilitates any number and type of other smart devices, such as (without limitation) autonomous machines or artificially intelligent agents, such as a mechanical agents or machines, electronics agents or machines, virtual agents or machines, electro-mechanical agents or machines, etc. Examples of autonomous machines or artificially intelligent agents may include (without limitation) robots, autonomous vehicles (e.g., self-driving cars, self-flying planes, self-sailing boats, etc.), autonomous equipment (self-operating construction vehicles, self-operating medical equipment, etc.), and/or the like. Further, “autonomous vehicles” are not limited to automobiles but that they may include any number and type of autonomous machines, such as robots, autonomous equipment, household autonomous devices, and/or the like, and any one or more tasks or operations relating to such autonomous machines may be interchangeably referenced with autonomous driving.

Further, for example, computing device 100 may include a computer platform hosting an integrated circuit (“IC”), such as a system on a chip (“SoC” or “SOC”), integrating various hardware and/or software components of computing device 100 on a single chip. For example, computing device 100 comprises a data processing device having one or more processors including (but not limited to) central processing unit 112 and graphics processing unit 114 that are co-located on a common semiconductor package.

As illustrated, in one embodiment, computing device 100 may include any number and type of hardware and/or software components, such as (without limitation) graphics processing unit (“GPU” or simply “graphics processor”) 114, central processing unit (“CPU” or simply “application processor”) 112, memory 104, network devices, drivers, and/or the like, as well as input/output (I/O) source(s) 108, such as touchscreens, touch panels, touch pads, virtual or regular keyboards, virtual or regular mice, ports, connectors, etc. Computing device 100 may include operating system (OS) 106 serving as an interface between hardware and/or physical resources of the computing device 100 and a user.

It is to be appreciated that a lesser or more equipped system than the example described above may be preferred for certain implementations. Therefore, any configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). Terms like “logic”, “module”, “component”, “engine”, “circuitry”, “element”, and “mechanism” may include, by way of example, software, hardware, firmware, and/or a combination thereof.

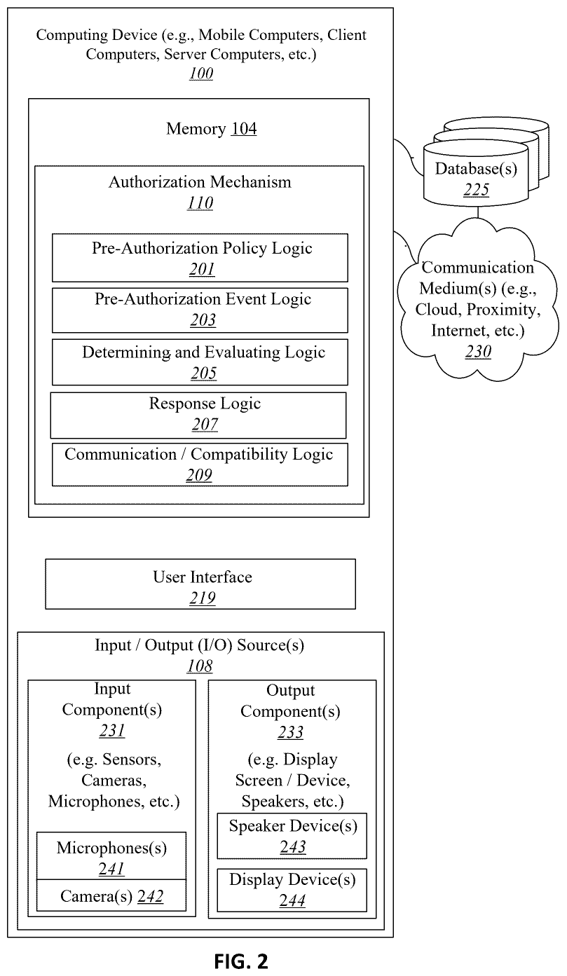

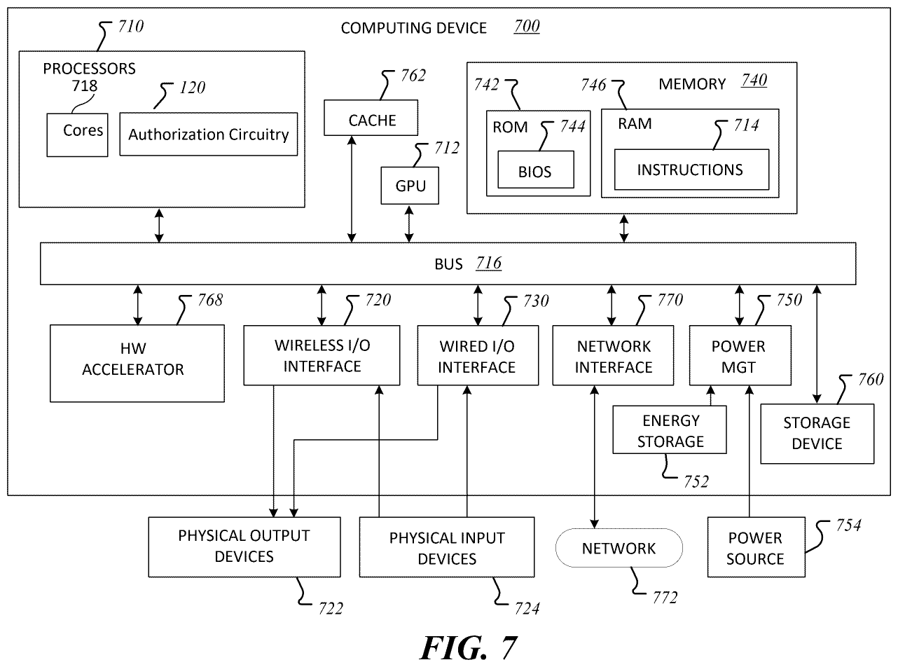

In one embodiment, as illustrated, the authorization mechanism 110 may be hosted by memory 104 (e.g., in the form of instructions stored in memory 104 as shown in FIG. 2) in communication with I/O source(s) 108, such as sensors, microphones, speakers, etc., of computing device 100. In another embodiment, authorization mechanism 110 may be part of or hosted by operating system 106. Similarly, in yet another embodiment, authorization mechanism 110 may be hosted by or part of central processing unit (“CPU” or simply “application processor”) 112 in the form of authorization circuitry 120 as shown in the processor of FIG. 7.

For example, authorization circuitry 120 and/or any elements of authorization mechanism 110 may be implemented by one or more analog or digital circuits, logic circuits, programmable processors, programmable controllers, GPUs, digital signal processors (DSPs), application specific integrated circuits (ASICs), programmable logic devices (PLDs), and/or field programmable logic devices (FPLDs).

It is contemplated that this novel technique is not limited to a software implementation or a hardware implementation and, as will be further described in this document, this novel technique may be applied and implemented in software, hardware, firmware, or any combination thereof. It is, therefore, further contemplated that embodiments are not limited to certain implementation or hosting of authorization mechanism 110 and that one or more portions or components of authorization mechanism 110 may be employed or implemented as hardware, software, firmware, or any combination thereof. Further, as used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events Computing device 100 may host network interface device(s) to provide access to a network, such as a LAN, a wide area network (WAN), a metropolitan area network (MAN), a personal area network (PAN), Bluetooth, a cloud network, a mobile network (e.g., 3rd Generation (3G), 4th Generation (4G), etc.), an intranet, the Internet, etc.

Network interface(s) may include, for example, a wireless network interface having antenna, which may represent one or more antenna(e). Network interface(s) may also include, for example, a wired network interface to communicate with remote devices via network cable, which may be, for example, an Ethernet cable, a coaxial cable, a fiber optic cable, a serial cable, or a parallel cable.

Embodiments may be provided, for example, as a computer program product which may include one or more machine-readable media having stored thereon machine-executable instructions that, when executed by one or more machines such as a computer, a data processing machine, a data processing device, network of computers, or other electronic devices, may result in the one or more machines carrying out operations in accordance with embodiments described herein. As described with reference to FIG. 1, a machine may include one or more processors, such as a CPU, a GPU, etc. A machine-readable medium may include, but is not limited to, floppy diskettes, optical disks, Compact Disc-Read Only Memories (CD-ROMs), magneto-optical disks, ROMs, Random Access Memories (RAMs), Erasable Programmable Read Only Memories (EPROMs), Electrically Erasable Programmable Read Only Memories (EEPROMs), magnetic or optical cards, flash memory, or other type of media/machine-readable medium suitable for storing machine-executable instructions.

For example, when reading any of the apparatus, method, or system claims of this disclosure to cover a purely software and/or firmware implementation, at least one element of authorization circuitry 120 and/or authorization mechanism 110 may be expressly defined to include a non-transitory computer readable storage device or storage disk such as a memory, a digital versatile disk (DVD), a compact disk (CD), a Blu-ray disk, etc., including the software and/or firmware.

Moreover, one or more elements of authorization circuitry 120 or authorization mechanism 110 may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document.

FIG. 2 illustrates authorization mechanism 110 of FIG. 1 according to some embodiments. For brevity, many of the details already discussed with reference to FIG. 1 are not repeated or discussed hereafter. In one embodiment, authorization mechanism 110 may include any number and type of elements or components, such as (but not limited to): pre-authorization policy logic 201; pre-authorization event logic 203; determining and evaluating logic 205; response logic 207; and communication/compatibility logic 209.

Computing device 100 further includes user interface 219 (e.g., graphical user interface (GUI)-based user interface, Web browser, cloud-based platform user interface, software application-based user interface, other user or application programming interfaces (APIs), etc.). Computing device 100 may further include I/O source(s) 108 having input component(s) 231, such as camera(s) 242 (e.g., Intel® RealSenseTM camera), microphone(s) 241, sensors, detectors, keyboards, mice, etc., and output component(s) 233, such as display device(s) or simply display(s) 244 (e.g., integral displays, tensor displays, projection screens, display screens, etc.), speaker devices(s) or simply speaker(s), etc.

Computing device 100 is further illustrated as having access to and/or being in communication with one or more database(s) 225 and/or one or more of other computing devices over one or more communication medium(s) 230 (e.g., networks such as a proximity network, a cloud network, an intranet, the Internet, etc.).

In some embodiments, database(s) 225 may include one or more of storage mediums or devices, repositories, data sources, etc., having any amount and type of information, such as data, metadata, etc., relating to any number and type of applications, such as data and/or metadata relating to one or more users, physical locations or areas, applicable laws, policies and/or regulations, user preferences and/or profiles, security and/or authentication data, historical and/or preferred details, and/or the like.

As aforementioned, computing device 100 may host I/O source(s) 108 including input component(s) 231 and output component(s) 233. In one embodiment, input component(s) 231 may include a sensor array including, but not limited to, microphone(s) 241, camera(s) 242, capacitors, radio components, radar components, scanners (e.g., fingerprint scanners), and/or accelerometers, etc. Similarly, output component(s) 233 may include any number and type of display device(s) 244, projectors, light-emitting diodes (LEDs), speaker(s) 243, and/or vibration motors, etc.

As aforementioned, terms like “logic”, “module”, “component”, “engine”, “circuitry”, “element”, and “mechanism” may include, by way of example, software, hardware, firmware, and/or any combination thereof. For example, logic may itself include or be associated with circuitry at one or more devices, such authorization circuitry 120 hosted by the CPU 112, respectively, of FIG. 1 having to facilitate or execute the corresponding logic to perform certain tasks.

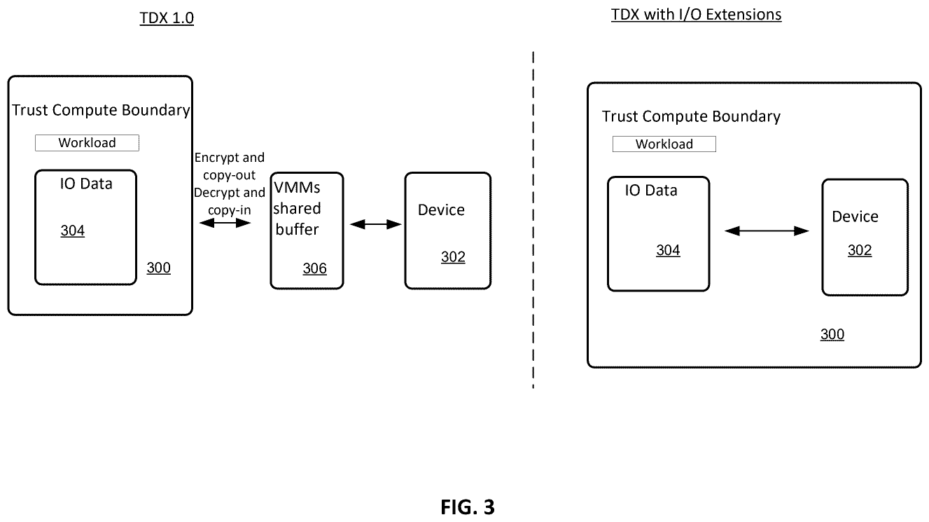

Embodiments provide for a novel technique, as facilitated by authorization mechanism 110 for enhancing the implementation of device seamless updates with a pre-authorization policy in TEE. With reference now to FIG. 3, a TDX 1.0 environment and a TDX-IO environment are illustrated. The TDX 1.0 environment enables a new confidential compute architecture (e.g., trust compute boundary 300) to support trust virtual machine (VM), also known as a trust domain (TD) in isolation from a virtual machine monitor (VMM)/hypervisor 306 and other non-TD software. The TDX with IO extensions supports TDX-IO. TDX-IO enables a host component (e.g., such as authorization circuitry 120 hosted by the CPU 112) to assign a virtual function (VF) or virtual interface (VF) of a device 302 to a specific TD 304. In one example, a device 302 may include a graphics processing unit (GPU), a smart network interface card (smart-NIC), storage and the like.

In some examples, a host component (e.g., TD 304) can offload some of its workload onto the device 302 within the confidential computing environment. Each device 302 may include firmware that performs some function for the device 302. As such, the TDX-IO environment may support a device firmware update without disrupting workloads running inside a TD 304. As such, a device 302 needs to maintain secure communication alive with an assigned TD 304 during the firmware update process. In addition, the TD 304 may approve or disapprove a new firmware version based on TD's security policy before the update is applied to the device 302.

In one embodiment, with reference again to FIG. 2, pre-authorization policy logic 201 sets a device update pre-authorization policy. In one example, the device update pre-authorization policy may be set while establishing a connection with the device. The device update pre-authorization policy may indicate whether the device is required to signal the pre-authorization event (e.g., a SPDM event) to the host before performing the update to the device. The device update pre-authorization policy (DeviceUpdatePreAuth policy) is implemented for each device. In another example, the pre-authorization policy logic 201 indicates that pre-authorization is required for updating the device. For example, a TD pre-authorization policy (TdPreAuth policy) may indicate whether a TD requires pre-authorization for a device update or whether the TD doesn't require pre-authorization for a device update. The TD pre-authorization policy may apply per device and per TD. For example, a device may be assigned to more than one TD. In this case, there is a TD pre-authorization policy set for each TD to which the device is assigned.

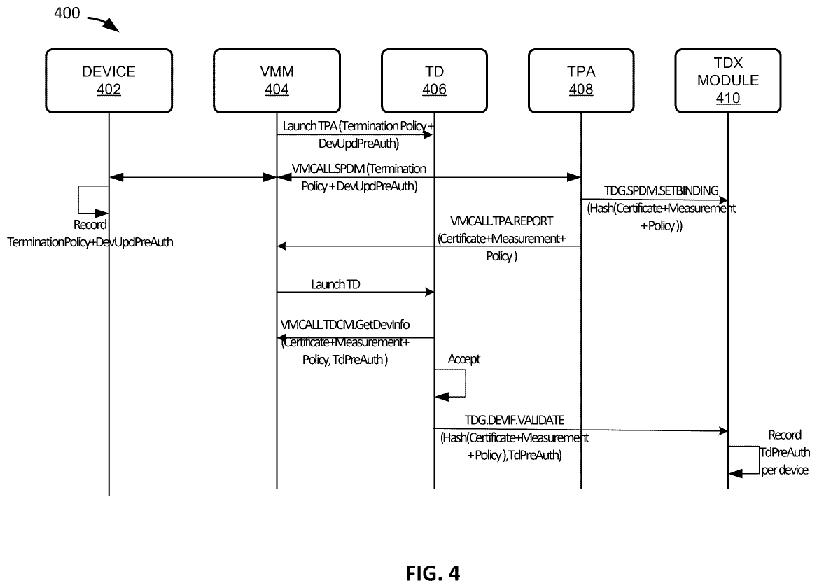

With reference now to FIG. 4, a TDX-IO flow 400 for a launch time pre-authorization policy setup according to some embodiments is illustrated. The TDX-IO flow 400 includes a device 402, a VMM 404, a TD 406, a TDX-IO Provision Agent (TPA) 408, and a TDX Module 410. In one example, the VMM 404 may inform the TPA 408 of the DeviceUpdatePreAuth policy in SPDM_POLICY HOB. If VMM 404 wants to support the device runtime update pre-authorization, the DeviceUpdatePreAuth policy may be set to 1, otherwise the DeviceUpdatePreAuth policy may be set to 0. Next, TPA 408 may set up the SPDM session with the device 402 via TDG.VP.VMCALL<Service.SPDM.PCIDOE>. In one example, the TPA 408 uses the Device UpdatePreAuth policy from the VMM 404. In another example, the TPA 408 uses an internal policy to disable the device runtime update. In some examples, the device 402 supports the DeviceUpdatePreAuth policy based on the SPDM version and the device 402 capability.

In some examples, the TPA 408 includes the DeviceUpdatePreAuth policy and the capability of the device 402 as part of SPDM_CERT_MEAS_DATA. In one example, the TPA 408 may set the hash to the TDX Module 410 via TDCALL[TDG.SPDM.SETBINDING]. In another step, the TPA 408 may report the DeviceUpdatePre Auth policy as part of SPDM_CERT_MEAS_DATA to the VMM 404 via TDG.VP.VMCALL<Service. TPA. ReportStatus>. Next, the TD 406 may be launched. In one example, the TD 406 is launched via get SPDM_CERT_MEAS_DATA to the VMM 404 via TDG.VP.VMCALL<Service.TDCM.GetDeviceInfo>. When the TD 406 requires pre-authorization for the device 402 update, the TD 406 may input TdPreAuth=TRUE. When the TD 406 does not require pre-authorization for the device 402 update, the TD 406 may input TdPreAuth=FALSE. The input may be reported to the VMM 404.

The TD 406 may evaluate DeviceUpdatePreAuth policy to determine if the TD 406 can accept the policy. In one example, the VMM 404 provider may communicate with the TD 406 owner to determine which DeviceUpdatePreAuth policy to use, avoiding unnecessary device 402 rejection by the TD 406. The TD 406 may verify DeviceUpdatePreAuth policy using TDCALL[TDG.DEVIF.VALIDATE] and accept the DEVIF. When the TD 406 requires pre-authorization for the device 402 update, the TD 406 may input TdPreAuth=TRUE in the TDCALL[TDG.DEVIF.VALIDATE]. In this regard, the TDX module 410 may record the request from the TD 406. When the TD 406 does not require pre-authorization for the device 402 update, the TD 406 may input TdPreAuth=FALSE. TdPreAuth=FALSE may be used by default.

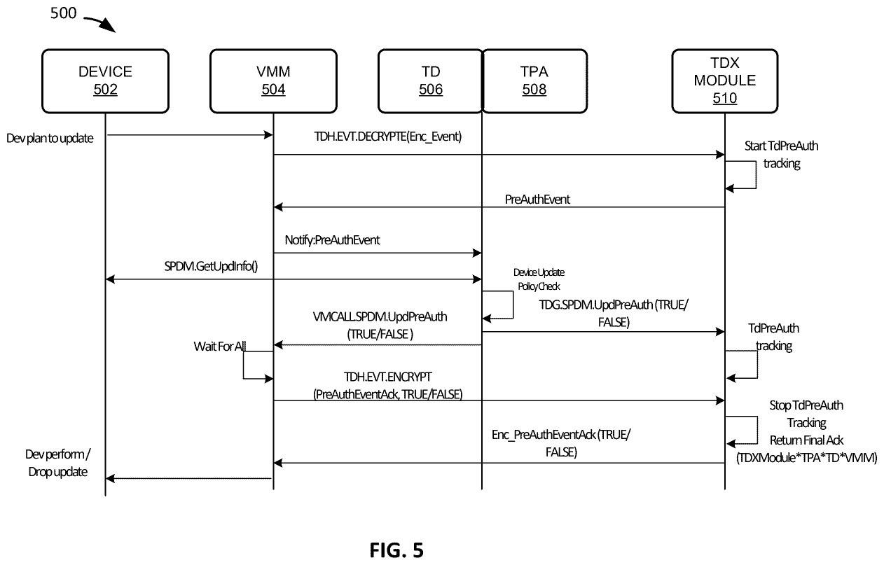

With reference again to FIG. 2, pre-authorization event logic 203 receives a pre-authorization event. In one example, the pre-authorization event is received from the device. For example, with reference now to FIG. 5, a TDX-IO flow 500 for a runtime pre-authorization control according to some embodiments illustrated. The TDX-IO flow 500 includes a device 502, a VMM 504, a TD 506, a TPA 508, and a TDX Module 510. It is appreciated that the TD 506 may represent multiple TDs 506. The pre-authorization (pre-auth) event may indicate an update for the device has been activated. As such, when the device 502 plans to perform the runtime update activation, the device 502 signals the pre-auth event in all registered SPDM sessions. The pre-auth event may include a timeout value to indicate that an acknowledgement (ACK) event should be returned within some amount of time. If the ACK event is not returned within the timeout value, the update may be dropped.

In another example, pre-authorization event logic 203 receives a pre-authorization event from an out of band (OBB) event. The OOB event may be received from at least one of a cloud orchestrator and an update initiator. For example, a cloud orchestrator can tell the TD 506 that a new device firmware image is available and ready for update. Then the TD 506 can use TDCALL to inform the TDX-module 510. In one example, the pre-auth event is encrypted. As such, the VMM 504 may get the SPDM event in the session, but the VMM 504 may not know what event it as it is encrypted. The VMM 504 may ask the TDX module 510 to decrypt the event via SEAMCALL[TDH.EVENT.DECRYPT]. Next, the TDX module 510 may decrypt the SPDM event. In this example, the TDX module 510 knows the SPDM event is the pre-auth event after decryption. The TDX module 510 may start TdPreAuth internal tracking.

The VMM 504 may get the plain text SPDM event from the TDX module 510. The VMM 504 may notify the TD 506 and the TPA 508 of the pre-auth event. In one example, the pre-auth event includes update information from the device 502. In this example, the notification to the TD 506 and the TPA 508 may include the update information. In one example, the update information includes a new security version number (SVN). In another example, a request may be sent to the device 502 for update information. For example, the TD 506 may use an SPDM command to get more specific update information (e.g., such as a new firmware measurement, a new certificate, and the like) With reference again to FIG. 2, determining and evaluating logic 205 determines whether the device is authorized to perform the update. In one example, to determine whether the device is authorized to perform the update, determining and evaluating logic 205 evaluates the update information from the device. In another example, determining and evaluating logic 205 sends a request to the device for update information, receives the update information from the device, and evaluates the update information to determine whether the device is authorized to the perform the update.

For example, with reference again to FIG. 5, the TD 506 may make a decision to accept or reject the pre-auth. The TD 506 may use TDCALL[TDG.SPDM.UpdatePreAuth(TRUE/FALSE)] to tell the TDX module 510 its decision. The TDX module 510 will track the response from all TDs 506. The TD 506 also uses TDG.VP.VMCALL<Service.TDCM.UpdatePreAuth(TRUE/FALSE)>to tell the VMM 504 its decision. The VMM 504 shall wait for all TDs' 506 response. After the VMM 504 collects all TD's 506 information, the VMM 504 may use SEAMCALL[TDH.EVENT.ENCRYPT] to the TDX module 510 to ask the TDX module 510 to encrypt the pre-auth event ACK. The VMM 504 can include its decision on accepting or rejecting the pre-auth.

When the TDX module 510 receives the pre-auth event ACK request, it stops tracking TdPreAuth. The final decision (accept or reject) is based upon all components'decision, including all TDs 506, TPA 508, VMM 504 and TDX module 510. If one component rejects the device update pre-auth, the result is to reject the device update pre-auth. In another example, if one component rejects the device update pre-auth, the VMM 504 can decide to terminate the rejecting TD 506. In one example, an administrator can be alerted by the VMM 504 for a human intervention. The TDX module 510 may encrypt the event ACK and return it to the VMM 504.

With reference again to FIG. 2, response logic 207 sends a response indicating whether the device is authorized to perform the update to the device. For example, the response may include whether the device update pre-auth is accepted or rejected. When the response indicates that the device is authorized to perform the update (e.g., the device update pre-auth is accepted), the device performs the update. When the response indicates that the device is unauthorized to perform the update (e.g., the device update pre-auth is rejected), the device drops the update. In one example, when the response indicates that the device is unauthorized to perform the update, the device terminates the connection with the host component and clears security sensitive information from the device before performing the update. In one example, the response is at least one of a pre-authorized event acknowledgment (e.g., an SPDM event ACK) and a standalone command (e.g., a SPDM command). With reference again to FIG. 5, the VMM 504 returns the SPDM event ACK result (e.g., the device update pre-auth result) to the device 502. The device 502 can decide to perform the update activation or drop the update based upon the SPDM event ACK result, as discussed herein.

It is contemplated that embodiments are not limited to any number or type of use-case scenarios, architectural placements, or component setups; however, for the sake of brevity and clarity, illustrations and descriptions are offered and discussed throughout this document for exemplary purposes but that embodiments are not limited as such. Further, throughout this document, “user” may refer to someone having access to one or more computing devices, such as computing device 100, and may be referenced interchangeably with “person”, “individual”, “human”, “him”, “her”, “child”, “adult”, “viewer”, “player”, “gamer”, “developer”, programmer”, and/or the like.

Communication/compatibility logic 209 may be used to facilitate dynamic communication and compatibility between various components, networks, database(s) 225, and/or communication medium(s) 230, etc., and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, Internet, Internet of Things, intranet, cellular network, proximity networks, such as Bluetooth, Bluetooth low energy (BLE), Bluetooth Smart, Wi-Fi proximity, Radio Frequency Identification, Near Field Communication, Body Area Network, etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, “circuitry”, and/or the like, may be referenced interchangeably and include, by way of example, software, hardware, firmware, and/or any combination thereof. In one example, “logic” may refer to or include a software component that works with one or more of an operating system, a graphics driver, etc., of a computing device, such as computing device 100. In another example, “logic” may refer to or include a hardware component that is capable of being physically installed along with or as part of one or more system hardware elements, such as an application processor, a graphics processor, etc., of a computing device, such as computing device 100. In yet another embodiment, “logic” may refer to or include a firmware component that is capable of being part of system firmware, such as firmware of an application processor or a graphics processor, etc., of a computing device, such as computing device 100.

It is contemplated that any number and type of components may be added to and/or removed from authorization mechanism 110 and/or authorization circuitry 120 of FIG. 1 and FIG. 2 to facilitate various embodiments including adding, removing, and/or enhancing certain features. For brevity, clarity, and ease of understanding of authorization mechanism 110 and/or authorization circuitry 120 of FIG. 1 and FIG. 2, many of the standard and/or known components, such as those of a computing device are not shown or discussed here. It is contemplated that embodiments, as described herein, are not limited to any technology, topology, system, architecture, and/or standard and are dynamic enough to adopt and adapt to any future changes.

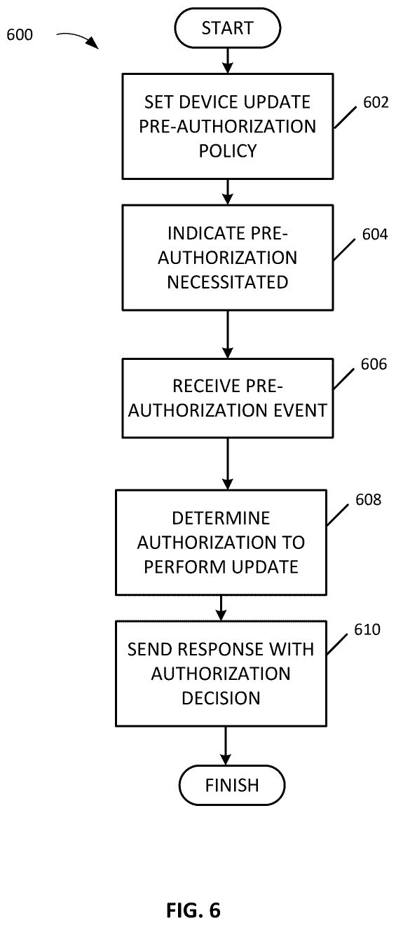

FIG. 6 illustrates a method 600 for a device seamless update with a pre-authorization policy according to some embodiments. Method 600 may be implemented on a computing device or a similar electronic device capable of executing instructions through at least one processor. Process 600 may begin at operation 602, where a device update pre-authorization policy is set while establishing a connection with the device. In one example, the device update pre-authorization policy indicates whether the device is required to signal the pre-authorization event before performing the update to the device. At operation 604, it is indicated that pre-authorization is necessitated for updating the device. At operation 606, a pre-authorization event is received from the device. In one example, the pre-authorization event indicates an update for the device has been activated. At operation 608, it is determined whether the device is authorized to perform the update. At operation 610, a response indicating whether the device is authorized to perform the update to the device is sent.

FIG. 7 is a schematic diagram of an illustrative electronic computing device to enhance the device seamless update with a pre-authorization policy processing according to some embodiments. In some embodiments, computing device 700 includes one or more processors 710 including processor cores 718 and authorization circuitry 120. In some embodiments, the computing device 700 includes one or more hardware accelerators 768. In some embodiments, the computing device is to implement processing of software-defined performance monitoring events, as provided in FIGS. 1-6 above.

The computing device 700 may additionally include one or more of the following: cache 762, a graphical processing unit (GPU) 712 (which may be the hardware accelerator in some implementations), a wireless input/output (I/O) interface 720, a wired I/O interface 730, system memory 740, power management circuitry 750, non-transitory storage device 760, and a network interface 770 for connection to a network 772. The following discussion provides a brief, general description of the components forming the illustrative computing device 700. Example, non-limiting computing devices 700 may include a desktop computing device, blade server device, workstation, laptop computer, mobile phone, tablet computer, personal digital assistant, or similar device or system.

In embodiments, the processor cores 718 are capable of executing machine-readable instruction sets 714, reading data and/or machine-readable instruction sets 714 from one or more storage devices 760 and writing data to the one or more storage devices 760. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like. For example, machine-readable instruction sets 714 may include instructions to implement security processing, as provided in FIGS. 1-6.

The processor cores 718 may include any number of hardwired or configurable circuits, some or all of which may include programmable and/or configurable combinations of electronic components, semiconductor devices, and/or logic elements that are disposed partially or wholly in a PC, server, mobile phone, tablet computer, or other computing system capable of executing processor-readable instructions.

The computing device 700 includes a bus 716 or similar communications link that communicably couples and facilitates the exchange of information and/or data between various system components including the processor cores 718, the cache 762, the graphics processor circuitry 712, one or more wireless I/O interface 720, one or more wired I/O interfaces 730, one or more storage devices 760, and/or one or more network interfaces 770. The computing device 700 may be referred to in the singular herein, but this is not intended to limit the embodiments to a single computing device 700, since in certain embodiments, there may be more than one computing device 700 that incorporates, includes, or contains any number of communicably coupled, collocated, or remote networked circuits or devices.

The processor cores 718 may include any number, type, or combination of currently available or future developed devices capable of executing machine-readable instruction sets.

The processor cores 718 may include (or be coupled to) but are not limited to any current or future developed single-or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 7 are of conventional design. Consequently, such blocks need not be described in further detail herein, as they will be understood by those skilled in the relevant art. The bus 716 that interconnects at least some of the components of the computing device 700 may employ any currently available or future developed serial or parallel bus structures or architectures.

The system memory 740 may include read-only memory (“ROM”) 742 and random-access memory (“RAM”) 746. A portion of the ROM 742 may be used to store or otherwise retain a basic input/output system (“BIOS”) 744. The BIOS 744 provides basic functionality to the computing device 700, for example by causing the processor cores 718 to load and/or execute one or more machine-readable instruction sets 714. In embodiments, at least some of the one or more machine-readable instruction sets 714 cause at least a portion of the processor cores 718 to provide, create, produce, transition, and/or function as a dedicated, specific, and particular machine, for example a word processing machine, a digital image acquisition machine, a media playing machine, a gaming system, a communications device, a smartphone, a neural network, a machine learning model, or similar devices.

The computing device 700 may include at least one wireless input/output (I/O) interface 720. The at least one wireless I/O interface 720 may be communicably coupled to one or more physical output devices 722 (tactile devices, video displays, audio output devices, hardcopy output devices, etc.). The at least one wireless I/O interface 720 may communicably couple to one or more physical input devices 724 (pointing devices, touchscreens, keyboards, tactile devices, etc.). The at least one wireless I/O interface 720 may include any currently available or future developed wireless I/O interface. Example wireless I/O interfaces include, but are not limited to: BLUETOOTH®, near field communication (NFC), and similar.

The computing device 700 may include one or more wired input/output (I/O) interfaces 730. The at least one wired I/O interface 730 may be communicably coupled to one or more physical output devices 722 (tactile devices, video displays, audio output devices, hardcopy output devices, etc.). The at least one wired I/O interface 730 may be communicably coupled to one or more physical input devices 724 (pointing devices, touchscreens, keyboards, tactile devices, etc.). The wired I/O interface 730 may include any currently available or future developed I/O interface. Example wired I/O interfaces include but are not limited to universal serial bus (USB), IEEE 1394 (“FireWire”), and similar.

The computing device 700 may include one or more communicably coupled, non-transitory, storage devices 760. The storage devices 760 may include one or more hard disk drives (HDDs) and/or one or more solid-state storage devices (SSDs). The one or more storage devices 760 may include any current or future developed storage appliances, network storage devices, and/or systems. Non-limiting examples of such storage devices 760 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more storage devices 760 may include one or more removable storage devices, such as one or more flash drives, flash memories, flash storage units, or similar appliances or devices capable of communicable coupling to and decoupling from the computing device 700.

The one or more storage devices 760 may include interfaces or controllers (not shown) communicatively coupling the respective storage device or system to the bus 716. The one or more storage devices 760 may store, retain, or otherwise contain machine-readable instruction sets, data structures, program modules, data stores, databases, logical structures, and/or other data useful to the processor cores 718 and/or graphics processor circuitry 712 and/or one or more applications executed on or by the processor cores 718 and/or graphics processor circuitry 712. In some instances, one or more data storage devices 760 may be communicably coupled to the processor cores 718, for example via the bus 716 or via one or more wired communications interfaces 730 (e.g., Universal Serial Bus or USB); one or more wireless communications interface 720 (e.g., Bluetooth®, Near Field Communication or NFC); and/or one or more network interfaces 770 (IEEE 802.3 or Ethernet, IEEE 802.11, or Wi-Fi®, etc.).

Machine-readable instruction sets 714 and other programs, applications, logic sets, and/or modules may be stored in whole or in part in the system memory 740. Such machine-readable instruction sets 714 may be transferred, in whole or in part, from the one or more storage devices 760. The machine-readable instruction sets 714 may be loaded, stored, or otherwise retained in system memory 740, in whole or in part, during execution by the processor cores 718 and/or graphics processor circuitry 712.

The computing device 700 may include power management circuitry 750 that controls one or more operational aspects of the energy storage device 752. In embodiments, the energy storage device 752 may include one or more primary (i.e., non-rechargeable) or secondary (i.e., rechargeable) batteries or similar energy storage devices. In embodiments, the energy storage device 752 may include one or more supercapacitors or ultracapacitors.

For convenience, the processor cores 718, the graphics processor circuitry 712, the wireless I/O interface 720, the wired I/O interface 730, the storage device 760, and the network interface 770 are illustrated as communicatively coupled to each other via the bus 716, thereby providing connectivity between the above-described components. In alternative embodiments, the above-described components may be communicatively coupled in a different manner than illustrated in FIG. 7. For example, one or more of the above-described components may be directly coupled to other components, or may be coupled to each other, via one or more intermediary components (not shown). In another example, one or more of the above-described components may be integrated into the processor cores 718 and/or the graphics processor circuitry 712. In some embodiments, all or a portion of the bus 716 may be omitted and the components are coupled directly to each other using suitable wired or wireless connections.

Flow charts representative of example hardware logic, machine readable instructions, hardware implemented state machines, and/or any combination thereof for implementing computing device 700, for example, are shown in FIGS. 4-6. The machine-readable instructions may be one or more executable programs or portion(s) of an executable program for execution by a computer processor such as the processor 710 shown in the example computing device 700 discussed above in connection with FIG. 7. The program may be embodied in software stored on a non-transitory computer readable storage medium such as a CD-ROM, a floppy disk, a hard drive, a DVD, a Blu-ray disk, or a memory associated with the processor 710, but the entire program and/or parts thereof could alternatively be executed by a device other than the processor 710 and/or embodied in firmware or dedicated hardware. Further, although the example program is described with reference to the flow charts illustrated in FIG. 4, many other methods of implementing the example computing device 700 may alternatively be used. For example, the order of execution of the blocks may be changed, and/or some of the blocks described may be changed, eliminated, or combined. Additionally, or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, wherein the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. Thus, the disclosed machine-readable instructions and/or corresponding program(s) are intended to encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example method of FIG. 6 may be implemented using executable instructions (e.g., computer and/or machine-readable instructions) stored on a non-transitory computer and/or machine-readable medium such as a hard disk drive, a solid-state storage device (SSD), a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

The following examples pertain to further embodiments. Example 1 is a method including setting a device update pre-authorization policy while establishing a connection with the device, indicating that pre-authorization is necessitated for updating the device, receiving a pre-authorization event from the device, where the pre-authorization event indicates an update for the device has been activated, determining whether the device is authorized to perform the update; and sending a response indicating whether the device is authorized to perform the update to the device.

In Example 2, the subject matter of Example 1 can optionally include wherein the device update pre-authorization policy indicates whether the device will signal the pre-authorization event before performing the update to the device.

In Example 3, the subject matter of any one of Examples 1-2 can optionally include wherein the pre-authorization event includes update information from the device.

In Example 4, the subject matter of any one of Examples 1-3 can optionally include wherein determining whether the device is authorized to perform the update comprises evaluating the update information from the device.

In Example 5, the subject matter of any one of Examples 1-4 can optionally include wherein in response to receiving the pre-authorization event from the device, determining whether the device is authorized to perform the update comprises: sending a request to the device for update information, receiving the update information from the device, and evaluating the update information.

In Example 6, the subject matter of any one of Examples 1-5 can optionally include wherein when the response indicates the device is authorized to perform the update, the device performs the update.

In Example 7, the subject matter of any one of Examples 1-6 can optionally include when the response indicates the device is unauthorized to perform the update, the device drops the update.

In Example 8, the subject matter of any one of Examples 1-7 can optionally include wherein the response is at least one of a pre-authorized event acknowledgement message and a standalone command.

Example 9 is at least one non-transitory machine-readable storage medium comprising instructions that, when executed, cause at least one processing device to at least: set a device update pre-authorization policy while establishing a connection with the device, indicate that pre-authorization is necessitated for updating the device, receive a pre-authorization event from the device, where the pre-authorization event indicates an update for the device has been activated, determine whether the device is authorized to perform the update, and send a response indicating whether the device is authorized to perform the update to the device.

In Example 10, the subject matter of Example 9 can optionally include wherein the device update pre-authorization policy indicates whether the device will signal the pre-authorization event before performing the update to the device.

In Example 11, the subject matter of any one of Examples 9-10 can optionally include wherein the pre-authorization event includes update information from the device.

In Example 12, the subject matter of any one of Examples 9-11 can optionally include wherein to determine whether the device is authorized to perform the update, the instructions that, when executed, further cause the at least one processing device to evaluate the update information from the device.

In Example 13, the subject matter of any one of Examples 9-12 can optionally include wherein when the pre-authorization event is received from the device, to determine whether the device is authorized to perform the update, the instructions that, when executed, further cause the at least one processing device to: send a request to the device for update information, receive the update information from the device, and evaluate the update information.

In Example 14, the subject matter of any one of Examples 9-13 can optionally include wherein when the response indicates the device is authorized to perform the update, the device performs the update.

In Example 15, the subject matter of any one of Examples 9-14 can optionally include wherein when the response indicates the device is unauthorized to perform the update, the device terminates the connection and clears security sensitive information from the device before the update is performed.

Example 16 is an apparatus comprising: one or more processors to: set a device update pre-authorization policy while establishing a connection with the device, indicate that pre-authorization is necessitated for updating the device, receive a pre-authorization event, where the pre-authorization event indicates an update for the device has been activated, determine whether the device is authorized to perform the update, and send a response indicating whether the device is authorized to perform the update to the device.

In Example 17, the subject matter of Example 16 can optionally include wherein the pre-authorization event is received from the device.

In Example 18, the subject matter of any one of Examples 16-17 can optionally include wherein the pre-authorization event is an out of band (OOB) event.

In Example 19, the subject matter of any one of Examples 16-18 can optionally include wherein the OOB event is received from at least one of a cloud orchestrator and an update initiator.

In Example 20, the subject matter of any one of Examples 16-19 can optionally include wherein when the response indicates the device is authorized to perform the update, the device performs the update, and wherein when the response indicates the device is unauthorized to perform the update, the device drops the update.

Example 21 is a system including one or more processors coupled to a memory, wherein the one or more processors are operative to perform the method of any one of Examples 1 to 8.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

1.-20. (canceled)

21. A method comprising:
establishing, by a computing device, a pre-authorization policy regarding one or more remote computing devices while establishing a connection with a remote computing device of the one or more remote computing devices;
receiving a pre-authorization event from the remote computing device, wherein the pre-authorization event indicates an update for the remote computing device has been activated;
determining whether the remote computing device is authorized to perform the update; and
sending a response authorizing the remote computing device to perform the update at the remote computing device.

22. The method of claim 21, wherein the update is authorized and performed in accordance with the pre-authorization policy, wherein the remote computing device is pre-authorized for update using a trusted execute environment (TEE) associated with the computing device, wherein the update is performed at the remote computing device using a virtual machine manager (VMM) associated with the remote computing device.

23. The method of claim 21, wherein in response to receiving the pre-authorization event from the device, determining whether the device is authorized to perform the update comprises:
sending a request to the device for update information;
receiving the update information from the device; and
evaluating the update information to determine whether the remote computing device is ready to perform the update in accordance with the pre-authorization policy.

24. The method of claim 21, wherein the computing device comprises processing circuitry coupled with a memory, the processing circuitry comprising one or more of application processing circuitry or graphics processing circuitry.

25. A computing device comprising:
processing circuitry coupled to a memory, the processing circuitry to:
establish a pre-authorization policy regarding one or more remote computing devices while establishing a connection with a remote computing device of the one or more remote computing devices;
receive a pre-authorization event from the remote computing device, wherein the pre-authorization event indicates an update for the remote computing device has been activated;
determine whether the remote computing device is authorized to perform the update; and
send a response authorizing the remote computing device to perform the update at the remote computing device.

26. The computing device of claim 25, wherein the update is authorized and performed in accordance with the pre-authorization policy, wherein the remote computing device is pre-authorized for update using a trusted execute environment (TEE) associated with the computing device, wherein the update is performed at the remote computing device using a virtual machine manager (VMM) associated with the remote computing device.

27. The computing device of claim 25, wherein in response to receiving the pre-authorization event from the device and determining whether the device is authorized to perform the update, the processing circuitry is further to:
send a request to the device for update information;
receive the update information from the device; and
evaluate the update information to determine whether the remote computing device is ready to perform the update in accordance with the pre-authorization policy.

28. The computing device of claim 25, wherein the processing circuitry comprises one or more of application processing circuitry or graphics processing circuitry.

29. At least one computer-readable medium having stored thereon instructions which, when executed, cause a computing device to perform operations comprising:
establishing a pre-authorization policy regarding one or more remote computing devices while establishing a connection with a remote computing device of the one or more remote computing devices;
receiving a pre-authorization event from the remote computing device, wherein the pre-authorization event indicates an update for the remote computing device has been activated;
determining whether the remote computing device is authorized to perform the update; and
sending a response authorizing the remote computing device to perform the update at the remote computing device.

30. The computer-readable medium of claim 29, wherein the update is authorized and performed in accordance with the pre-authorization policy, wherein the remote computing device is pre-authorized for update using a trusted execute environment (TEE) associated with the computing device, wherein the update is performed at the remote computing device using a virtual machine manager (VMM) associated with the remote computing device.

31. The computer-readable medium of claim 29, wherein in response to receiving the pre-authorization event from the device, determining whether the device is authorized to perform the update comprises:
sending a request to the device for update information;
receiving the update information from the device; and
evaluating the update information to determine whether the remote computing device is ready to perform the update in accordance with the pre-authorization policy.

32. The computer-readable medium of claim 29, wherein the computing device comprises one or more processors coupled to a memory, the one or more processors having one or more application processors or one or more graphics processors.
